(19) United States
(12) Patent Application Publication
(10) Pub. No.: US 2024/0347967 A1
(43) Pub. Date: Oct. 17, 2024

(54) CONNECTOR

(71) Applicant: Yazaki Corporation, Tokyo (JP)

(72) Inventors: Tooru KOBAYASHI, Shizuoka (JP); Hideki Homma, Tokyo (JP)

(73) Assignee: Yazaki Corporation, Tokyo (JP)

(21) Appl. No.: 18/756,124

(22) Filed: Jun. 27, 2024

Related U.S. Application Data
(63) Continuation of application No. PCT/JP2023/004884, filed on Feb. 14, 2023.

(30) Foreign Application Priority Data
Feb. 28, 2022 (JP) 2022-028866

(51) Int. Cl. H01R 13/629; H01R 13/518

(52) U.S. Cl. CPC H01R 13/62938; H01R 13/518; H01R 13/62955

(57) ABSTRACT

A connector includes a housing, and a lever that is rotatably assembled to the housing. The housing has a frame and a sub-housing that is inserted into the frame. A lever insertion slit, which is formed along an insertion direction of the sub-housing and whose one end on a near side of the sub-housing is open, is formed on the frame. A rotational shaft, which protrudes towards the housing and is inserted into the lever insertion slit to make the lever rotatable with respect to the frame, is provided on the lever. A restricting portion, which is located between the frame and the sub-housing and restricts the lever from being spaced from the frame, is provided on the rotational shaft.

### CROSS REFERENCE TO RELATED APPLICATION

The present application is a continuation of International Application No. PCT/JP2023/004884, filed on Feb. 14, 2023, and based upon and claims the benefit of priority from Japanese Patent Application No. 2022-28866, filed on Feb. 28, 2022, the entire contents of which are incorporated herein by reference.

### TECHNICAL FIELD

The present disclosure relates to a connector.

### BACKGROUND

A connector disclosed in JP2015-122182A includes a housing, and a lever rotatably assembled to the housing. In the connector, axial shafts are formed on the housing, and shaft holes into which the axial shafts are inserted, respectively, are formed on the lever. The lever is rotatably assembled to the housing by inserting the axial shafts into the shaft holes, respectively.

In the above connector, a restricting portion (protrusion) that restricts the lever from being separated (dropping out) from the housing is formed at each end of the axial shafts. A notch is formed on each circumference of the shaft holes of the lever, which coincides with the restricting portion only when the lever is in a specific rotational position to allow the lever to be assembled into the housing.

When assembling the lever to the housing, the lever is placed in the specific rotational position to match the restricting portions with the notches, respectively. The axial shafts are inserted into the shaft holes, respectively, by passing the restricting portions through the notches, respectively. The lever can be prevented from separating from the housing by disposing the restricting portions on the axial shafts, respectively, and the lever can be rotated stably.

### SUMMARY OF THE INVENTION

However, in the connector disclosed in JP2015-122182A, it is necessary to match the restricting portions with the notches, respectively, when assembling the lever to the housing. Therefore, during assembly work, the lever must be assembled into the housing while keeping the rotational position of the lever, and thus assembling workability reduces.

An object of the present disclosure is to provide a connector that can improve its assembling workability.

A connector according to the present disclosure includes a housing; and a lever that is rotatably assembled to the housing, wherein the housing has a frame and a sub-housing that is inserted into the frame, wherein a lever insertion slit, which is formed along an insertion direction of the sub-housing into the frame and whose one end on a near side of the sub-housing is open, is formed on the frame, a rotational shaft, which protrudes towards the housing and is inserted into the lever insertion slit to make the lever rotatable with respect to the frame, is provided on the lever, and a restricting portion, which is located between the frame and the sub-housing and restricts the lever from being spaced from the frame, is provided on the rotational shaft.

According to the connector, provided can be the connector that can improve its assembling workability.

### BRIEF DESCRIPTION OF DRAWINGS

FIG. 1 is an exploded perspective view of a connector according to an embodiment;

FIG. 2 is a front view (vertically cross-sectioned partially) of the connector;

FIG. 3 is an enlarged view of a featured portion shown in FIG. 2;

FIG. 4 is a perspective view of the featured portion of a lever of the connector;

FIG. 5 is a side view of the connector just before connecting with a mating connector;

FIG. 6 is a horizontal cross-sectional view of the connector just before connecting with the mating connector; and

FIG. 7 is a vertical cross-sectional view of the connector after its connection completion with the mating connector.

### DETAILED DESCRIPTION OF THE INVENTION

Hereinafter, a connector according to an embodiment will be described with reference to the drawings.

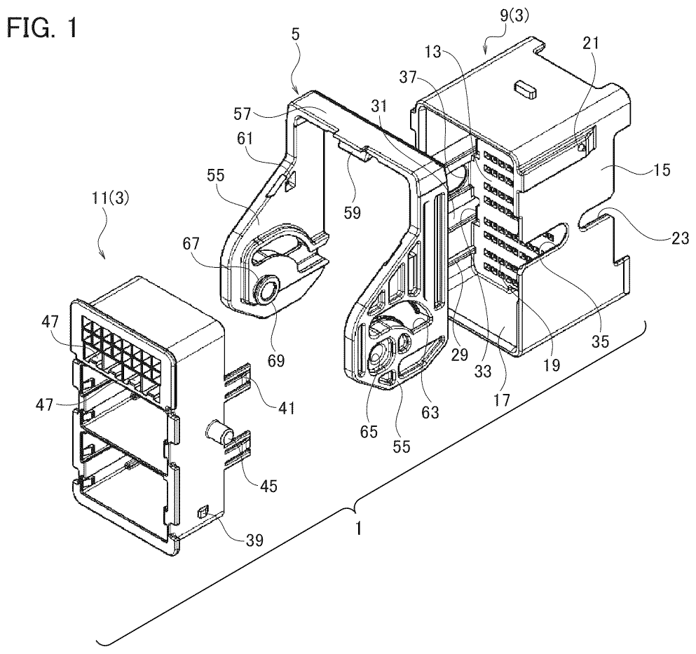

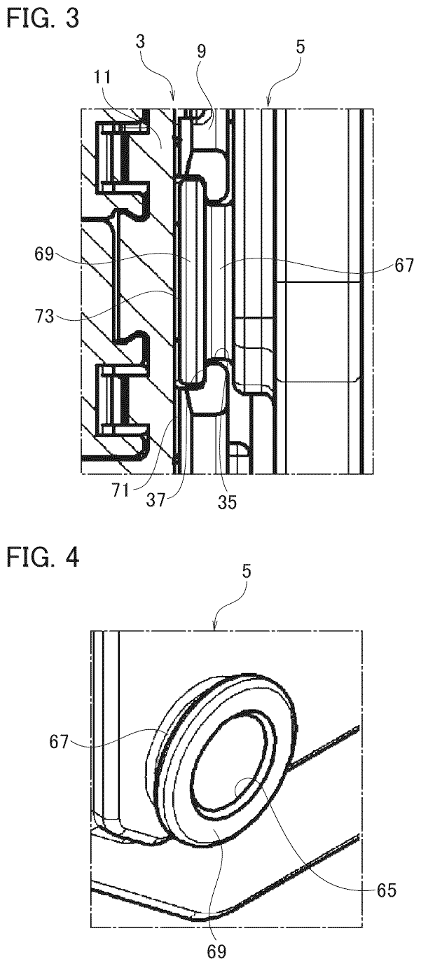

As shown in FIG. 1 through FIG. 7, the connector 1 according to the present embodiment can be connected with a mating connector 101. The connector 1 includes a housing 3 and a lever 5. The housing 3 stores terminals 7. The mating connector 101 stores mating terminals 105. The connector 1 is connected with the mating connector 101 by rotating the lever 5, and thus the terminals 7 and the mating terminals 105 are electrically connected, respectively.

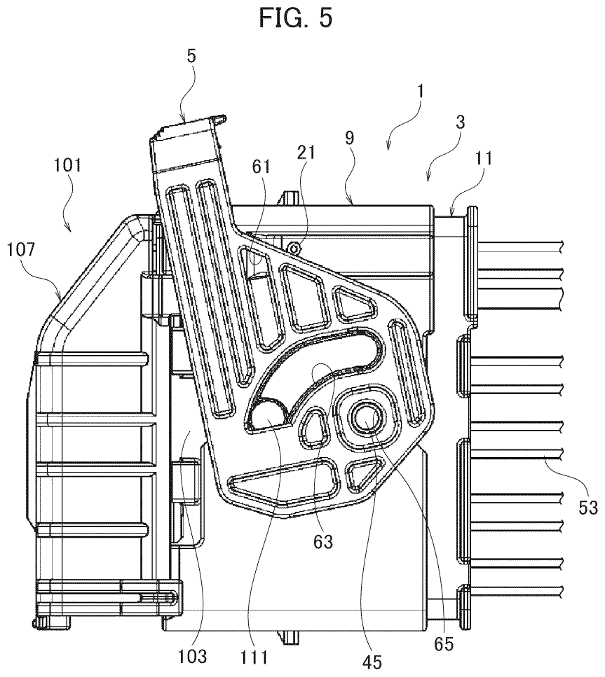

As shown in FIG. 5 through FIG. 7, the mating connector 101 includes a mating housing 103, the mating terminals 105, a cover 107 and a detection member 109.

The mating housing 103 is formed of an insulating material such as, for example, synthetic resin. The mating housing 103 is formed to have a box shape that can be connected with the housing 3 of the connector 1. Cam pins 111 project outwardly from outer surfaces of both side walls of the mating housing 103, respectively. Mating engagement protrusions 113 protrude outwardly from outer surfaces of upper and lower walls of the mating housing 103, respectively.

Plural mating terminal storage chambers 115 are formed inside the mating housing 103, which can store the mating terminals 105 extended along a connecting direction with the connector 1, respectively. The mating housing 103 is configured of a frame and terminal storage members stored in the frame, and the mating terminal storage chambers 115 are formed inside the terminal storage members.

Ends of the mating terminal storage chambers 115 on a far side of the connector 1 are open to allow insertion of the mating terminals 105 therein. In addition, ends of the mating terminal storage chambers 115 on a near side of the connector 1 are open to allow insertion of the tab-shaped connection sections 51 of the terminals 7. In each inside of the mating terminal storage chambers 115, provided is an elastically-deformable mating engagement lance 117 that is engaged with the mating terminal 105 and holds the mating terminal 105 in the mating terminal storage chamber 115.

The mating terminal(s) 105 is made of conductive material. The mating terminal 105 is a female terminal having a box-shaped mating connection section 119 into which the tab-shaped connection section 51 of the terminal 7 can be inserted. The mating terminal 105 is extended in the mating terminal storage chamber 115 toward the connector 1. The mating terminal 105 is electrically connected to an end of a mating wire 121 electrically connected to a power supply, an equipment or the like.

The mating terminal 105 electrically connected to the end of the mating wire 121 is stored in the mating terminal storage chamber 115 through the opening on a far side of the connector 1. The box-shaped mating connection sections 119 of the mating terminals 105 stored in the mating terminal storage chamber 115 is positioned in line with the openings of the mating terminal storage chambers 115 on a far side of the connector 1, respectively. The mating wires 121 are drawn out from the openings, on a far side of the connector 1, of the mating terminal storage chambers 115 in which the mating terminals 105 is stored, respectively. The plural mating wires 121 drawn out from the mating housing 103 are covered by the cover 107.

The cover 107 is formed of an insulating material such as, for example, synthetic resin. The cover 107 is formed to have a box shape so as to cover the plural mating wires 121 drawn out from the mating housing 103. The cover 107 is assembled to the mating housing 103 via plural engaging portions. An elastically-deformable detection arm 123 is formed on an outer surface of the cover 107. At a free end of the detection arm 123, a lever locked portion 125 is formed that can engage a lever locking portion 59 of the lever 5. The lever locked portion 125 engages with the lever locking portion 59 in a rotational completion position of the lever 5.

A detection hole 127 is formed in a free end of the detection arm 123. The detection hole 127 is a through hole. Below the free end of the detection arm 123 of the cover 107, a detection temporary-engagement portion 129 and a detection engagement-completion portion 131 are formed. The detection member 109 is assembled to the portion where the detection temporary-engagement portion 129 and the detection engagement-completion portion 131 are formed.

The detection member 109 is formed of an insulating material such as, for example, synthetic resin. The detection member 109 is formed to have a rectangular shape so that it can be accommodated in its assembly space. The detection member 109 is movable in the height direction of the cover 107 with respect to the assembly space. A detection engagement protrusion 133, which can be engaged with the detection temporary-engagement portion 129 or the detection engagement-completion portion 131 of the cover 107, protrudes from the outer surface of the detection member 109. The engagement of the detection engagement protrusion 133 with the detection temporary-engagement portion 129 keeps the detection member 109 in its temporary-engagement position. On the other hand, the engagement of the detection engagement protrusion 133 with the detection engagement-completion portion 131 keeps the detection member 109 in its engagement-completion position.

An elastically-deformable elastic arm 135 is formed at the end of the detection member 109. A detection portion 137 protruding outward is formed at a free end of the elastic arm 135. When the detection member 109 is in the temporary-engagement position, the detection portion 137 is in contact with the lever locked portion 125. When the detection member 109 is in the temporary-engagement position, the detection member 109 cannot move to the engagement-completion position due to the contact between the lever locked portion 125 and the detection portion 137. While the detection member 109 is in the engagement-completion position, the detection portion 137 is located within the detection hole 127.

The detection member 109 is held in the temporary-engagement position when assembled to the cover 107, and is moved from the temporary-engagement position to the engagement-completion position after the lever 5 has completed its rotation. When the lever 5 has reached the rotational completion position, the lever locked portion 125 and the lever locking portion 59 are engaged with each other. In this state, the lever locking portion 59 and the detection portion 137 in the temporary-engagement position contact each other, and the detection member 109 is elastically deformed toward the cover 107 (inward). When the elastic arm 135 is elastically deformed, the contact area between the lever locked portion 125 and the detection portion 137 reduces to allow the detection member 109 to move from the temporary-engagement position to the engagement-completion position. At this time, the detection portion 137 overcomes the lever locked portion 125, and the detection member 109 reaches the engagement-completion position. While the detection member 109 is located in the engagement-completion position, it can be detected that the lever 5 is placed in the rotational completion position and that the mating connector 101 and the connector 1 are connected properly.

If the rotation of the lever 5 to the rotational completion position is insufficient, the lever locking portion 59 is positioned outside of the lever locked portion 125. In this state, the lever locking portion 59 does not contact the detection portion 137 in the temporary-engagement position, and the elastic arm 135 is not elastically deformed inward. Therefore, even if one tries to move the detection member 109 from the temporary-engagement position to the engagement-completion position, the detection member 109 cannot be moved because the detection portion 137 is in contact with the lever locked portion 125. Since the detection member 109 is not placed in the engagement-completion position, it can be detected that the lever 5 is not located in the rotational completion position and that the mating connector 101 and the connector 1 may not be connected properly.

As shown in FIG. 1 through FIG. 7, the connector 1 includes the housing 3 and the lever 5. The housing 3 includes a frame 9 and a sub-housing 11.

The frame 9 is formed of an insulating material such as, for example, synthetic resin. The frame 9 includes a support wall 13, a mating hood section 15, and a hood section 17.

The support wall 13 is formed to have a flat-plate shape. The support wall 13 is disposed between the sub-housing 11 and the mating housing 103. The support wall 13 is in contact with the sub-housing 11 and the mating housing 103 when the terminals 7 and the mating terminals 105 are electrically connected. Plural insertion holes 19 through which the tab-shaped connection sections 51 of the terminals 7 are inserted, respectively, are formed on the support wall 13. The plural insertion holes 19 are collated in line with the openings of the plural mating terminal storage chambers 115, respectively.

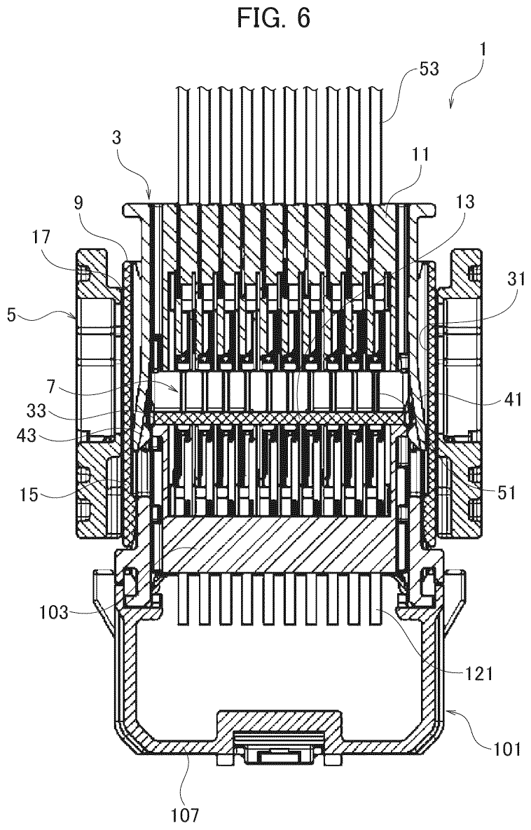

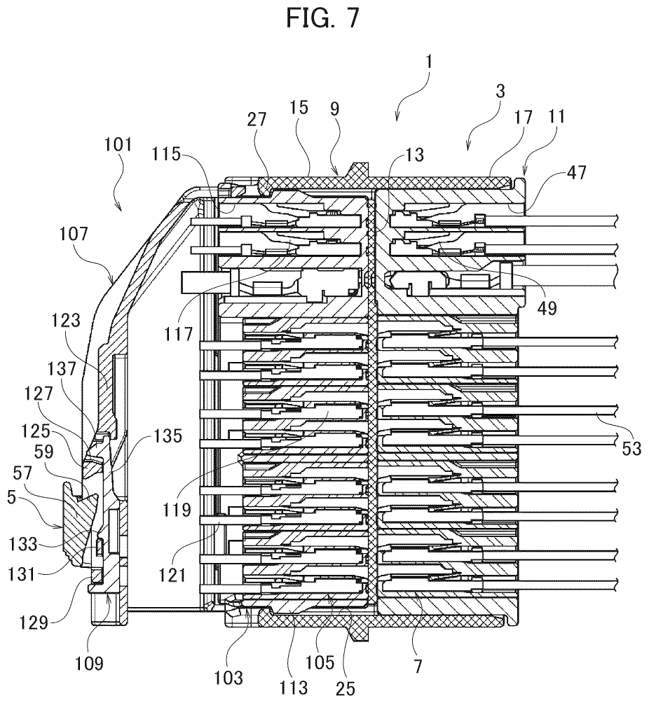

In a temporary position of the support wall 13 (see FIG. 6), tips of the tab-shaped connection sections 51 are inserted into the insertion holes 19, respectively, and then supported by them. In a completion position of the support wall 13 (see FIG. 7), the tab-shaped connection sections 51 exposed from the insertion holes 19 are inserted into the box-shaped mating connection sections 119 of the mating terminals 105, respectively. The support wall 13 is movable between the temporary position and the completion position while being interposed between the sub-housing 11 and the mating housing 103. In the present embodiment, the support wall 13 contacts the mating housing 103 in the temporary position and moves together with the mating housing 103 from the temporary position to the completion position.

The support wall 13 keeps positions of the tab-shaped connection sections 51 with respect to the box-shaped mating connection sections 119 until it moves from the temporary position to the completion position. Therefore, the tab-shaped connection sections 51 are inserted stably into the box-shaped mating connection sections 119, respectively, and thereby the electrical connection reliability between the terminals 7 and the mating terminals 105 can be maintained.

The mating hood section 15 is a member continued from the support wall 13 and extended toward the mating housing 103. The mating hood section 15 is formed to have a box shape that can store the mating housing 103 therein. From outer surfaces of both side walls of the mating hood section 15, lever protrusions 21 protrude outward, respectively. From each end edge of both side walls of the mating hood section 15 facing to the mating housing 103, pin slits 23 are formed, respectively. The pin slits 23 are formed along the insertion direction of the mating housing 103 into the mating hood section 15, and their ends on a near side of the mating housing 103 are open. When the mating housing 103 is inserted into the mating hood section 15, cam pins 111 of the mating housing 103 is inserted into the pin slits 23, respectively. Tips of the cam pins 111 inserted into the pin slits 23 protrude from outer surfaces of the frame 9, respectively.

On inner surfaces of upper and lower walls of the mating hood section 15, mating grooves 25 are formed, respectively. The mating groove(s) 25 is formed from the hood section 17 to the mating hood section 15. A mating engaged portion 27, with which the mating engaging protrusion 113 of the mating housing 103 is engaged, is formed at an end of the mating groove 25 on a near side of the mating housing 103. The engagement between the mating engaging protrusion 113 and the mating engaged portion 27 prevents the mating housing 103 from being pulled out of the mating hood section 15. When the mating engaging protrusion 113 and the mating engaged portion 27 are engaged, the mating housing 103 is in contact with the support wall 13 (see FIG. 6 and FIG. 7). In addition, the openings of the mating terminal storage chambers 115 on a near side of the connector 1 are positioned in line with the insertion holes 19 formed on the support wall 13, respectively.

The hood section 17 is a member continued from the support wall 13 and extended toward the sub-housing 11. The hood section 17 is formed to have a box shape that can store the sub-housing 11 therein. On inner surfaces of both side walls of the hood section 17, grooves 29 are formed, respectively. The groove(s) 29 is formed from the mating hood section 15 to the hood section 17. An engaged portion (not illustrated in the drawings) is formed at an end of the groove 29 on a near side of the sub-housing 11. On inner surfaces of both side walls of the hood section 17, plural acceptance grooves 31 are also formed. The acceptance grooves 31 are formed from the hood section 17 to the mating hood section 15. Therefore, engagement holes 33 are formed on the support wall 13 to pass through the acceptance grooves 31, respectively.

Lever insertion slits 35 are formed on both side walls of the hood section 17, respectively. The lever insertion slits 35 are formed along the insertion direction of the sub-housing 11 into the hood section 17, and their ends on a near side of the sub-housing 11 are open. Engagement steps 37 are formed on inner surfaces 71 of the hood section 17 along inner edges of the lever insertion slits 35, respectively. The engagement steps 37 are formed all along the inner edges of the lever insertion slits 35, respectively. The hood section 17 stores the sub-housing 11.

The sub-housing 11 is formed of an insulating material such as, for example, synthetic resin. The sub-housing 11 is formed to have a box shape that can be stored within the hood section 17. Engaging protrusions 39, which can be engaged with the engaged portions (not illustrated in the drawings) formed at ends of the grooves 29 of the hood section 17, are protruded from outer surfaces of both side walls of the sub-housing 11, respectively. The engagement of the engaging protrusions 39 with the engaged portions prevents the sub-housing 11 from being pulled out of the hood section 17.

Elastically-deformable elastic tabs 41 are extended from end edges of both side walls of the sub-housing 11 facing to the frame 9, respectively, so as to be associated with the plural acceptance grooves 31 of the hood section 17. A front protrusion 43 and a rear protrusion (not illustrated in the drawings) that protrude toward the inside of the sub-housing 11 are formed on each inner face of the elastic tabs 41. The front protrusion 43 and the rear protrusion are spaced apart so that the edge of the engagement hole 33 of the support wall 13 can be held between them.

When the sub-housing 11 is inserted into the hood section 17, the elastic tab(s) 41 is inserted into the engagement hole 33 of the support wall 13 and the edge of the engagement hole 33 is engaged between the front protrusion 43 and the rear protrusion. The support wall 13 is held in the temporary position (see FIG. 6) in a state where the elastic tabs 41 are engaged with the engagement holes 33. In the temporary position of the support wall 13, the ends of the tab-shaped connection sections 51 of the terminals 7 are inserted into the insertion holes 19 of the support wall 13, respectively, and held thereby. When the mating housing 103 is stored in the mating hood section 15, the front protrusions 43 contact the mating housing 103 and thus the elastic tabs 41 are elastically deformed. When the elastic tabs 41 are elastically deformed, the engagement of the edges of the engagement holes 33 with the front protrusions 43 and the rear protrusion is disengaged and the support wall 13 can move to the completion position.

Axial shafts 45 project outward from outer surfaces of both side walls of the sub-housing 11, respectively. The axial shaft(s) 45 is formed to have a cylindrical shape from its base to its end. In other words, the axial shaft 45 is formed as a simple cylinder without any formation on its outer circumferential surface. Therefore, the axial shaft 45 is easy to form (no slide core structure is required in a molding die for resin molding). When the sub-housing 11 is inserted into the hood section 17 of the frame 9, the axial shafts 45 are inserted into the lever insertion slits 35 of the hood section 17, respectively.

Plural terminal storage chambers 47 capable of storing the terminals 7 are formed at an upper portion of the sub-housing 11. The terminal storage chambers 47 are extended along the connection direction of the sub-housing 11 with the mating connector 101. Note that plural terminal storage members, each of which is provided with the plural terminal storage chambers 47, are stored in a lower portion of the sub-housing 11.

Ends of the terminal storage chambers 47 on a far side of the frame 9 are open to allow insertion of the terminals 7 therein. In addition, ends of the terminal storage chambers 47 on a near side of the frame 9 are open to expose the tab-shaped connection sections 51 of the terminals 7 to the outside. In each inside of the terminal storage chambers 47, provided is an elastically-deformable engagement lance 49 that is engaged with the terminal 7 and holds the terminal 7 in the terminal storage chamber 47.

The terminal(s) 7 is made of conductive material. The terminal 7 is a male terminal having the tab-shaped connection section 51 extending toward the frame 9. The connection section 51 extends outward from the opening of the terminal storage chamber 47 on a near side of the frame 9 and is exposed to the outside. The terminal 7 is electrically connected to an end of a wire 53 electrically connected to a power source, an equipment or the like.

The terminal 7 electrically connected to the end of the wire 53 is stored in the terminal storage chamber 47 through the opening of the terminal storage chamber 47 on a far side of the frame 9. The tab-shaped connection sections 51 of the terminals 7 stored in the terminal storage chambers 47 are exposed to the outside through the openings of the terminal storage chambers 47 on a near side of the frame 9, respectively. The wires 53 are drawn out from the openings, on a far side of the frame 9, of the terminal storage chambers 47 in which the terminals 7 are stored, respectively.

When the sub-housing 11 is stored in the hood section 17 of the frame 9, the tips of the tab-shaped connection sections 51 of the terminals 7 are inserted into the insertion holes 19 of the support wall 13, respectively. At this time, the support wall 13 of the frame 9 is placed in the temporary position to support the tab-shaped connection sections 51. When the mating housing 103 is inserted into the mating hood section 15 of the frame 9, the mating housing 103 and the elastic tabs 41 contact each other and the engagement between the elastic tabs 41 and the engagement holes 33 are disengaged. When the mating housing 103 and the frame 9 are moved toward the sub-housing 11, the support wall 13 moves from the temporary position to the completion position toward the sub-housing 11. Along with this movement, the tab-shaped connection sections 51 are inserted into the box-shaped mating connection sections 119, respectively, and the terminals 7 and the mating terminals 105 are electrically connected, respectively. This connection between the connector 1 and the mating connector 101 is done by the rotation of the lever 5.

The lever 5 is formed of an insulating material such as, for example, synthetic resin. The lever 5 has a pair of side walls 55, 55 facing both side walls of the frame 9, respectively, and a connecting portion 57 connecting the pair of side walls 55, 55. The connecting portion 57 of the lever 5 has a lever locking portion 59. The pair of side walls 55, 55 of the lever 5 have engagement holes 61 that engage with the lever protrusions 21 of the frame 9, respectively. A cam groove 63, which engages with the cam pin 111 of the mating housing 103, is formed respectively in the pair of side walls 55, 55 of the lever 5 along the rotational path of the lever 5.

Shaft holes 65, into which the axial shafts 45 of the sub-housing 11 are respectively inserted, are formed on the pair of side walls 55, 55 of the lever 5, respectively. An inner diameter of the shaft hole 65 is made slightly larger than an outer diameter of the axial shaft 45, and its interior is formed to have a hollow cylindrical shape corresponding to the shape of the axial shaft 45. As mentioned above, the axial shaft 45 is formed as a simple cylinder, and no pull-out prevention protrusion (no restricting portion) is formed on the outer circumferential surface of the axial shaft 45. Therefore, no cutout or the like is formed around the shaft hole 65 to allow the insertion of such a protrusion (restricting portion). Thus, the axial shaft 45 can be inserted into the shaft hole 65 in any rotational position of the lever 5.

When the sub-housing 11 is inserted into the hood section 17 with the lever 5 assembled into the sub-housing 11, the axial shafts 45 are inserted into the lever insertion slits 35, respectively, and the lever 5 becomes rotatable with respect to the frame 9. The lever 5 is held in its rotational initial position by the engagement of the lever protrusions 21 and the engagement holes 61 (see FIG. 5). In the rotational initial position of lever 5, the openings of the cam grooves 63 face to the mating connector 101.

When the mating housing 103 is stored in the mating hood section 15 in the rotational initial position of the lever 5, the cam pins 111 of the mating housing 103 are inserted into the cam grooves 63, respectively. When the lever 5 is rotated from the rotational initial position, the cam pins 111 move along the cam grooves 63 and the mating housing 103 and the frame 9 are moved toward the sub-housing 11. Due to the above-mentioned movement of the mating housing 103 and the frame 9, the tab-shaped connection sections 51 are inserted into the box-shaped mating connection sections 119, respectively, and thereby the terminals 7 and the mating terminals 105 are electrically connected with each other, respectively. When the lever 5 reaches its rotational completion position, the lever 5 is held in the rotational completion position by engagement of the lever locking portion 59 with the lever locked portion 125 of the cover 107.

Since there is no structure between the axial shaft 45 and the shaft hole 65 to restrict the axial shaft 45 from pulling out of the shaft hole 65, the axial shaft 45 may be pulled out of the shaft hole 65. If the axial shaft 45 is pulled out of the shaft hole 65, the pair of side walls 55, 55 of the lever 5 may get spaced from the housing 3, and the rotation of the lever 5 may become unstable. In addition, the lever 5 may detach from the housing 3. Therefore, a restricting portion 69 is formed on a hollow cylindrical portion 67 where the shaft hole 65 is formed. The hollow cylindrical portion 67 functions as the rotational shaft of the lever 5 and is formed in said lever 5.

The hollow cylindrical portion 67 is provided in each of the pair of side walls 55, 55 of the lever 5 and projects inwards from each inner face of the side walls 55. The shaft hole 65 is formed in the center of the hollow cylindrical portion 67. The hollow cylindrical portion 67 is to have a hollow cylindrical shape. An outer diameter of the hollow cylindrical portion 67 is slightly smaller than a width of the lever insertion slit 35. An extending length of the hollow cylindrical portion 67 from the inner face of the side wall 55 is made equal to a thickness of a wall of the frame 9. When the sub-housing 11 to which the lever 5 has been assembled is inserted into the hood section 17, the hollow cylindrical portions 67 are inserted into the lever insertion slits 35, respectively. When the lever 5 is rotated, the outer surface of the hollow cylindrical portion 67 comes into sliding contact with the inner edge of the lever insertion slit 35. The hollow cylindrical portion 67 therefore functions as the rotational shaft that supports the lever 5 rotatably.

The restricting portion 69 is a flange formed to be extended radially outward from an end edge of the hollow cylindrical portion 67. The restricting portion 69 is formed to have an annular shape made continuous in the circumferential direction of the hollow cylindrical portion 67. An outer diameter of the restricting portion 69 is larger than the width of the lever insertion slit 35. A thickness of the restricting portion 69 is made equal to a depth of the engagement step 37 formed on the inner surface 71 of the hood section 17 along the inner edge of the lever insertion slit 35.

When the hollow cylindrical portion 67 is inserted into the lever insertion slit 35, the restricting portion 69 is positioned between the frame 9 and the sub-housing 11 and engages the engagement step 37 to prevent the lever 5 from separating from the housing 3. Since the engagement of the restricting portion 69 with the engagement step 37 prevents the lever 5 from separating from the housing 3, the axial shafts 45 are also prevented from being pulled out of the shaft holes 65, respectively. Since the separation of the lever 5 from the housing 3 is prevented, the rotation of the lever 5 can also be made stable. Furthermore, the lever 5 is also prevented from detaching from the housing 3. In addition, since the restricting portion 69 is formed along the entire circumference of the hollow cylindrical portion 67, the axial shaft 45 can be prevented from being pulled out of the shaft hole 65 in the entire rotational range of the lever 5.

The restricting portion 69 engages with the engagement step 37 formed on the inner surface 71 of the frame 9. An end face 73, facing to the sub-housing 11, of the restricting portion 69 engaging the engagement step 37 is made flush with the inner surface 71 of the frame 9. Therefore, the restricting portion 69 does not protrude into the interior of the frame 9, and thus the frame 9 and the sub-housing 11 can be arranged in close proximity to restrict the size of the housing 3 from increasing.

To connect the connector 1 with the mating connector 101, the lever 5 is assembled to the sub-housing 11 at first by inserting the axial shafts 45 into the shaft holes 65, respectively. Next, the sub-housing 11 is inserted into the hood section 17 of the frame 9. At this time, the engaging protrusions 39 and the engaged portions are engaged, respectively, and the elastic tabs 41 and the engagement holes 33 are engaged, respectively, so that the support wall 13 is placed in the temporary position to support the tips of the tab-shaped connection sections 51.

Subsequently, the mating housing 103 is inserted into the mating hood section 15 of the frame 9 and then stored therein. At this time, the mating engaging protrusions 113 and the mating engaged portions 27 are engaged with each other, respectively, and the mating housing 103 contacts the support wall 13, so that the mating housing 103 and the frame 9 become movable together. Along with the contact of the support wall 13 and the mating housing 103, the elastic tabs 41 are elastically deformed by being contacted with the mating housing 103, and the engagements between the elastic tabs 41 and the engagement holes 33 are disengaged.

Next, the lever 5 is rotated from the rotational initial position to the rotational completed position. The rotation of the lever 5 causes the cam pins 111 to move along cam grooves 63, respectively, and the mating housing 103 and the frame 9 are moved towards the sub-housing 11. Along with the movement of the frame 9, the support wall 13 is moved from the temporary position to the completion position with respect to the sub-housing 11. As a result of this movement, the tab-shaped connection sections 51 are inserted into the box-shaped mating connection sections 119, respectively, and the terminals 7 and the mating terminals 105 are electrically connected, respectively.

In a state where the lever 5 is positioned in the rotational completion position, the detection member 109 is moved from the temporary-engagement position to the engagement-completion position. If the detection member 109 is not placed in the engagement-completion position, the lever 5 is rotated towards the rotational completion position and the detection member 109 is moved to the engagement-completion position again. When the detection member 109 is moved to the engagement-completion position, the connection between the connector 1 and the mating connector 101 is completed.

The connector 1 according to the present embodiment includes the housing 3 and the lever 5 that is rotatably assembled to the housing 3. The housing 3 has the frame 9 and the sub-housing 11 that is inserted into the frame 9. The lever insertion slit 35, which is formed along the insertion direction of the sub-housing 11 into the frame 9 and whose one end on a near side of the sub-housing 11 is open, is formed on the frame 9. The hollow cylindrical portion 67, which protrudes towards the housing 3 and is inserted into the lever insertion slit 35 to make the lever 5 rotatable with respect to the frame 9, is provided on the lever 5 as the rotational shaft. The restricting portion 69, which is located between the frame 9 and the sub-housing 11 and restricts the lever 5 from being spaced from the frame 9, is provided on the rotational shaft (the hollow cylindrical portion 67).

Since the one end of the lever insertion slit 35 on a near side of the sub-housing 11 is open, the rotational shaft (the hollow cylindrical portion 67) can be inserted into the lever insertion slit 35 in any rotational position of the lever 5. By inserting the rotational shaft (the hollow cylindrical portion 67) into the lever insertion slit 35, the lever 5 can be rotatably assembled to the housing 3 with respect to the frame 9. The restricting portion 69 provided on the rotational shaft (the hollow cylindrical portion 67) is located between the frame 9 and the sub-housing 11 and the restricting portion 69 prevents the lever 5 from being spaced from the housing 3, so that the rotation of the lever 5 can be made stable. In addition, the lever 5 can also be prevented from detaching from the housing 3.

Therefore, according to the connector 1 in the present embodiment, the rotational shaft (the hollow cylindrical portion 67) can be inserted into the lever insertion slit 35 through its opening in any rotational position of the lever 5. This makes it easy to assemble the lever 5 to the housing 3 and improves the assembling workability.

In addition, the axial shaft 45 protruded toward the lever 5 is formed on the sub-housing 11, and the rotational shaft (the hollow cylindrical portion 67) is formed to have a hollow cylindrical shape and the axial shaft 45 is inserted into the rotational shaft (the hollow cylindrical portion 67). Therefore, the rotation of the lever 5 can be made stable by inserting the axial shaft 45 into the rotational shaft (the hollow cylindrical portion 67). Furthermore, the lever 5 can be assembled to the sub-housing 11 by inserting the axial shaft 45 into the rotational shaft (the hollow cylindrical portion 67). The lever 5 can be assembled to the housing 3 by inserting the sub-housing 11 to which the lever 5 has been assembled into the frame 9 so that the rotational shaft (the hollow cylindrical portion 67) is inserted into the lever insertion slit 35. Therefore, the sub-housing 11 to which the lever 5 has been assembled can be handled as a single part, and facilitates parts management. In addition, the axial shaft 45 can be protected by inserting the axial shaft 45 into the rotational shaft (the hollow cylindrical portion 67).

In addition, the restricting portion 69 is formed along the entire circumference of the rotational shaft (the hollow cylindrical portion 67). Therefore, the lever 5 can be restricted from being spaced from the housing 3 in the entire rotational range of the lever 5.

Furthermore, the axial shaft 45 is formed to have a simple cylindrical shape from its base to its end. Therefore, the shape of the axial shaft 45 is not complicated and the shaft 45 can be easily formed.

In addition, the engagement step 37 slidably engaging with the restricting portion 69 of the lever 5 is formed on the inner surface 71 of the frame 9. Therefore, when the restricting portion 69 is slidably engaged with the engagement step 37, the restricting portion 69 is stored in the engagement step 37 without protruding towards the sub-housing 11 and the end face 73 of the restricting portion 69 is flush with the inner surface 71 of the frame 9. As a result, the size of the housing 3 can be restricted from increasing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

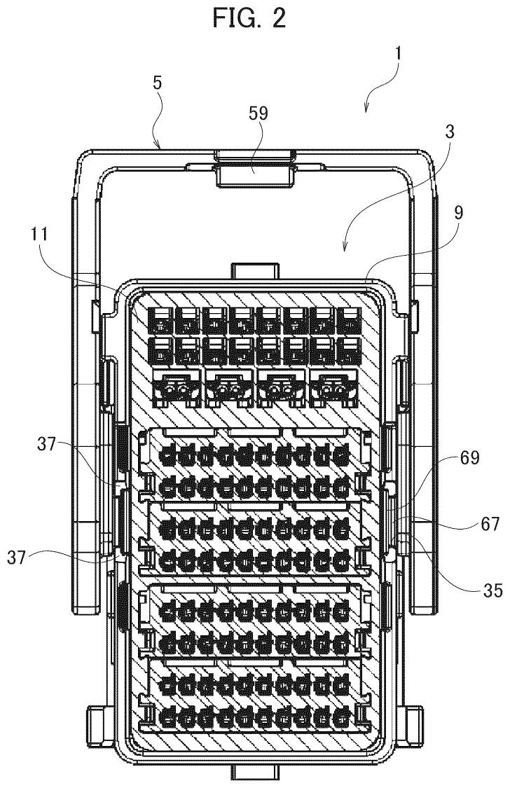

For example, the plural terminal storage members, each of which is provided with the plural terminal storage chambers 47, are stored in a lower portion of the sub-housing 11 in the above embodiment (see FIG. 1 and FIG. 2). In other words, the terminal storage members are formed as separated parts independent from the sub-housing 11. However, the terminal storage members may be integrally molded with the sub-housing 11.

In addition, the rotational shaft (the hollow cylindrical portion 67) is formed to have a hollow cylindrical shape so that the axial shaft 45 can be inserted thereinto in the above embodiment. However, the rotational shaft may be formed to have a solid cylindrical shape. In this case, it is not necessary to provide the axial shaft 45 on the sub-housing 11 (a hole, into which the solid cylindrical rotational shaft is inserted, is formed).

1. A connector comprising:
a housing; and
a lever that is rotatably assembled to the housing,
wherein the housing has a frame and a sub-housing that is inserted into the frame,
wherein a lever insertion slit, which is formed along an insertion direction of the sub-housing into the frame and whose one end on a near side of the sub-housing is open, is formed on the frame,
a rotational shaft, which protrudes towards the housing and is inserted into the lever insertion slit to make the lever rotatable with respect to the frame, is provided on the lever, and
a restricting portion, which is located between the frame and the sub-housing and restricts the lever from being spaced from the frame, is provided on the rotational shaft.

2. The connector according to claim 1,
wherein an axial shaft protruded toward the lever is formed on the sub-housing, and
wherein the rotational shaft is formed to have a hollow cylindrical shape and the axial shaft is inserted into the rotational shaft.

3. The connector according to claim 1,
wherein the restricting portion is formed along an entire circumference of the rotational shaft.

4. The connector according to claim 2,
wherein the axial shaft is formed to have a simple cylindrical shape from a base thereof to an end thereof.

5. The connector according to claim 1,
wherein the engagement step slidably engaging with the restricting portion is formed on an inner surface of the frame.
